(19) United States
(12) Patent Application Publication
(10) Pub. No.: US 2018/0304849 A1
(43) Pub. Date: Oct. 25, 2018

(54) PROTECTION CONTROL DEVICE

(71) Applicant: DENSO CORPORATION, Kariya-city, Aichi-pref. (JP)

(72) Inventors: Kazuhisa HASHIMOTO, Kariya-city, Aichi-pref. (JP); Asei WAKABAYASHI, Kariya-city, Aichi-pref. (JP); Takeshi HORIGUCHI, Kariya-city, Aichi-pref. (JP)

(21) Appl. No.: 15/767,963

(22) PCT Filed: Oct. 4, 2016
(86) PCT No.: PCT/JP2016/079374

§ 371 Date: Apr. 12, 2018

(30) Foreign Application Priority Data
Oct. 16, 2015 (JP) 2015-204866

(51) Int. Cl. B60R 21/34; B60R 21/0134; B60R 19/48

(52) U.S. Cl. CPC B60R 21/34; B60R 2021/343; B60R 19/483; B60R 21/0134

(57) ABSTRACT

A protection control device is for being used in a vehicle having a protection device and includes an output value acquisition unit, an object recognition unit, a collision subject identification unit, a collision position acquisition unit, and an operation determination unit. The operation determination unit uses, as an operation threshold, a predetermined default threshold when a collision position acquired by the collision position acquisition unit is not in a low output area of a front end portion where the output value of the collision sensor is likely to be lower than another area of the front end portion. The operation determination unit uses, as the operation threshold, a low output area threshold when the collision position is in the low output area of the front end portion. The low output area threshold is less than the predetermined default threshold.

### CROSS REFERENCE TO RELATED APPLICATION

This application is based on Japanese Patent Application No. 2015-204866 filed on Oct. 16, 2015, the disclosure of which is incorporated herein by reference.

### TECHNICAL FIELD

The present disclosure relates to a protection control device that controls an operation of a protection device for protecting a person colliding with a vehicle.

### BACKGROUND ART

When a pedestrian collides with a front end portion of a vehicle such as a front bumper (so-called first collision), there is a possibility that the pedestrian falls over the vehicle, and a head portion and a breast portion of the pedestrian collide with a body of the vehicle (so-called second collision). The front end portion includes a corner portion.

In order to reduce a damage of the pedestrian in the second collision, a system has been proposed that operates a protection device for protecting the pedestrian colliding with the vehicle when the first collision with the pedestrian is detected (for example, patent literature 1). For example, the protection device for protecting a pedestrian colliding with a vehicle is exemplified by an air-bag that is developed to several regions such as a window shield, a pillar portion, a cowl top, and the like, and a pop-up hood device that holds up a rear portion of a hood.

In such a system, a threshold (hereinafter, referred to as an operation threshold) for operating the protection device is preliminarily set with respect to an output value of a collision sensor for detecting the first collision. When the output value of the collision sensor is greater than the operation threshold, a device for controlling the operation of the protection device (hereinafter, referred to as a protection control device) operates the protection device.

However, the front end portion of the vehicle includes an area (hereinafter, referred to as a low output area) where the output value of the collision sensor is likely to be lower than another area of the front end portion even when the same impact is applied.

For example, in the corner portion of the front end portion, the impact of the collision is dispersed along a shape of the corner portion. Specifically, the impact of the collision is released in a side direction of the vehicle and thus a force acting in a rear direction of the vehicle is reduced. As a result, the output value of the collision sensor is likely to be lower than a collision around a center of the vehicle in a width direction of the vehicle.

The rear direction corresponds to a direction extending from a front end toward a rear end of the vehicle. The side direction corresponds to a direction parallel to the width direction of the vehicle and extending from an inner side toward an outer side of the vehicle.

When a position (hereinafter referred to as a collision position) where the pedestrian collides with the front end portion of the vehicle is in the low output area, there is a possibility that the output value of the collision sensor does not reach the operation threshold and the protection device does not operate. From viewpoints of protecting the pedestrian, the protection device is desired to operate.

Additionally, the protection device needs to operate when the vehicle collides with not only the pedestrian but also a crewed bicycle. That is, the crew of the bicycle is also a protection subject to be protected in the collision with the vehicle. There is a possibility that a similar issue occurs in the collision of the vehicle and the crewed bicycle to the collision of the vehicle and the pedestrian.

### PRIOR ART LITERATURE

### Patent Literature

Patent literature 1: JP 2004-17812 A

### SUMMARY OF INVENTION

It is an object of the present disclosure to provide a protection control device capable of reducing a possibility that a protection device does not operate due to a collision position of a front end portion of a vehicle.

According to an aspect of the present disclosure, a protection control device is for being used in a vehicle having a protection device for protecting a person colliding with the vehicle, and the protection device includes an output value acquisition unit, an object recognition unit, a collision subject identification unit, a collision position acquisition unit, and an operation determination unit.

The output value acquisition unit is configured to acquire an output value of a collision sensor for detecting a collision of a front end portion of the vehicle with another object. The object recognition unit is configured to acquire information about an object existing in front of the vehicle. The collision subject identification unit is configured to identify a collision subject based on the information acquired by the object recognition unit, the collision subject being a subject colliding with the vehicle. The collision position acquisition unit is configured to acquire a collision position where the collision subject collides with the front end portion of the vehicle.

The operation determination unit is configured to operate the protection device when the output value, which is acquired by the output value acquisition unit, is greater than an operation threshold for operating the protection device. The operation determination unit uses, as the operation threshold, a predetermined default threshold when the collision position, which is acquired by the collision position acquisition unit, is not in a low output area of the front end portion. The operation determination unit uses, as the operation threshold, a low output area threshold when the collision position, which is acquired by the collision position acquisition unit, is in the low output area of the front end portion. The low output area is an area where the output value of the collision sensor is likely to be lower than another area of the front end portion. The low output area threshold is less than the predetermined default threshold.

According to the aspect of the present disclosure, the collision position acquisition unit is configured to acquire the collision position in the front end portion of the vehicle. When the acquired collision position is in the low output area, the operation determination unit determines whether to operate the protection device by using the low output area threshold less than the predetermined default threshold used when the collision position is not in the low output area.

According to the aspect of the present disclosure, even when the output value of the collision sensor is less than the predetermined default threshold because the collision position is in the low output area, the protection device operates when the output value is greater than the low output threshold. Accordingly, a possibility that the protection device does not operate due to the collision position in the front end portion is reduced.

### BRIEF DESCRIPTION OF DRAWINGS

The above and other objects, features and advantages of the present disclosure will become more apparent from the following detailed description made with reference to the accompanying drawings, in which:

FIG. 1 is a block diagram showing a schematic configuration of a protection device control system according to an embodiment of the present disclosure;

FIG. 2 is a diagram for explaining a low output area;

FIG. 3 is a diagram for explaining the low output area;

FIG. 4 is a diagram showing an area included in the low output area;

FIG. 5 is a block diagram showing a schematic configuration of an ECU;

FIG. 6 is a block diagram showing an example of a configuration of an operation determination unit;

FIG. 7 is a conceptual diagram showing a bicycle in a horizontal posture with respect to a vehicle;

FIG. 8 is a conceptual diagram showing a bicycle in a vertical posture with respect to a vehicle;

FIG. 9 is a block diagram showing an example of a configuration of an operation determination unit according to a modification 2;

FIG. 10 is a block diagram showing an example of a configuration of an operation determination unit according to a modification 3; and

FIG. 11 is a conceptual diagram showing a relationship between a size of a collision subject and a low output area threshold.

### DESCRIPTION OF EMBODIMENTS

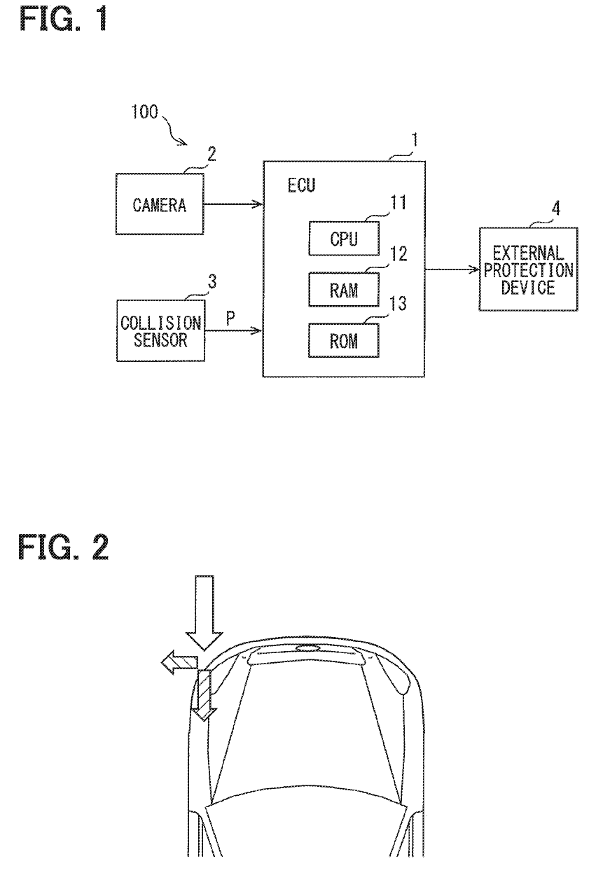

An embodiment of the present disclosure will be described with reference to the drawings. FIG. 1 is a diagram showing an example of a schematic configuration of a protection device control system 100 according to the present embodiment. The protection device control system 100 is mounted to a vehicle. For convenience, a vehicle to which the protection device control system 100 is mounted may be referred to as a host vehicle.

The protection device control system 100 is a system for protecting a person colliding with the host vehicle. For example, the person to be protected is expected to include a pedestrian and a crew of a bicycle. In other embodiment, the protection device control system 100 may protect a crew of a two-wheel movable body other than the bicycle such as a motorized bicycle and a two-wheel automobile.

As shown in FIG. 1, the protection device control system 100 of the present embodiment includes an electronic control unit (ECU) 1, a camera 2, a collision sensor 3, and an external protection device 4. The ECU 1 is connected to each of the camera 2, the collision sensor 3 and the external protection device 4 through a local area network built in the vehicle.

The ECU 1 is configured as a general computer. The ECU 1 includes a CPU 11, a RAM 12, a ROM 13, I/O, and bus lines connecting these elements. The RAM 12 functions as a main memory device (so-called memory) of the CPU 11. The ROM 13 functions as a sub memory device (so-called storage).

The ROM 13 stores a program (hereinafter, referred to as a control program) causing the general computer to function as the ECU 1 of the present embodiment. For example, the control program is stored in a non-transitory tangible storage medium such as a flash-memory, a ROM and the like. When the CPU 11 implements the control program, a method corresponding to the control program is implemented.

The ROM 13 stores data indicating an area (hereinafter, referred to as a low output area) of a front end portion of the host vehicle where an output value of the collision sensor 3 is lower than the other portion even when the same impact is applied. The low output area will be described in detail later. The front end portion includes a corner portion.

The ECU 1 controls an operation of the external protection device 4 based on signals input by the camera 2 and the collision sensor 3. The ECU 1 corresponds to a protection control device. The details of the functions of the ECU 1 will be described after the camera 2, the collision sensor 3 and the external protection device 4 are described.

The camera 2 is an optical camera. For example, a CMOS camera and a CCD camera may be employed as the camera 2. The camera 2 may be placed adjacent to an upper end portion of a window shield (e.g., around a room mirror) so as to shoot a predetermined range in front of the host vehicle. An image data shot by the camera 2 is sequentially provided to the ECU 1.

The position of the camera 2 is not limited to the position around the room mirror, and the camera 2 is at least attached to a position where the camera 2 does not block a sight of a driver in front of the host vehicle. In other embodiment, an infrared camera or a near-infrared camera may be employed as the camera 2. Furthermore, a stereo camera may be employed as the camera 2.

The collision sensor 3 is a sensor for detecting an initial collision (so-called first collision) of the front end portion of the host vehicle and an object other than the host vehicle. The collision sensor 3 is placed in the front end portion of the vehicle along a width direction of the vehicle. The collision sensor 3 outputs a value according to a measurement of an impact of a collision to the ECU 1.

In one example, the collision sensor 3 is provided by a pressure chamber and a pressure sensor. The pressure chamber is arranged substantially parallel to a front bumper. The pressure sensor senses a pressure in the pressure chamber. That is, the collision sensor 3 outputs a variation value of the pressure according to a deformation of the pressure chamber as an output value.

The collision sensor 3 is not limited to a pressure-type sensor. For example, a sensor detecting a collision based on a variation of a light intensity output by a light fiber placed along a body of a vehicle may be employed as the collision sensor 3. An acceleration sensor may be employed as the collision sensor 3.

The external protection device 4 is a device for protecting a person colliding with the host vehicle. For example, the external protection device 4 includes a pop-up hood device that immediately holds up a rear portion of an engine hood (in other word, bonnet), and an external air-bag that is developed to several regions outside of the vehicle. The external air-bag includes various air-bag depending on a region to which the air-bag is developed. For example, the external air-bag includes a pillar air-bag that is developed to cover a front surface of a front pillar, and a cowl top air-bag that is developed to cover a cowl top. The external protection device 4 operates based on an instruction of the ECU 1. The external protection device 4 corresponds to a protection device.

Next, the low output area stored in the ROM 13 will be described with reference to FIG. 2 to FIG. 4. As described above, the low output area is the area of the front end portion of the host vehicle where the output value of the collision sensor 3 is likely to be lower than the other portion.

For example, the low output area includes the corner portion. As shown in FIG. 2, in the corner portion, the impact of the collision is dispersed along a shape of the corner portion. The impact of the collision is released in a side direction of the vehicle and thus a force acting in a rear direction of the vehicle is reduced. As a result, an output value of a collision of the pedestrian or the like with the corner portion of the front end portion is likely to be lower than an output value of a collision around a center of the vehicle in a width direction of the vehicle.

The rear direction corresponds to a direction extending from a front end toward a rear end of the vehicle. The side direction corresponds to a direction parallel to the width direction of the vehicle and extending from an inner side toward an outer side of the vehicle. In FIG. 2, a white arrow conceptually expresses the measurement of the impact applied to the vehicle. Hatched arrows conceptually express a component propagating in the rear direction and a component propagating in the width direction of the impact applied to the corner portion.

The low output area may include an area other than the corner portion. When a member relatively less likely to deform is placed adjacent to the collision sensor 3, the member blocks the deformation of the vehicle body caused by the impact of the collision and the propagation of the impact to the collision sensor 3. As a result, the output value of the collision sensor 3 is reduced. The low output area may include an area where such a relatively hard member blocking the deformation of the vehicle body is placed adjacent to the collision detection sensor.

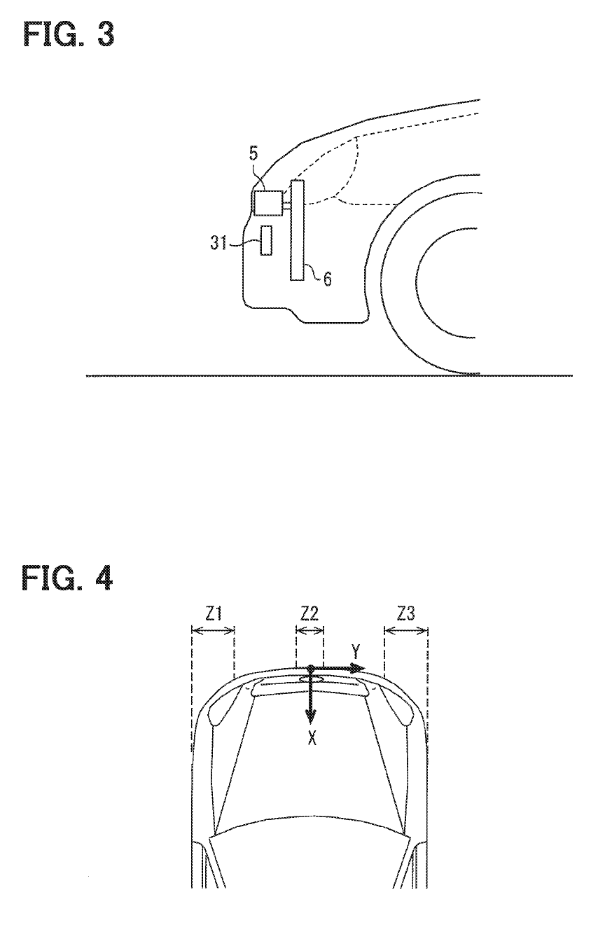

For example, as shown in FIG. 3, in the center portion of the width direction of the vehicle, a distance sensor 5 is fixed to a radiator 6 so that the distance sensor 5 is placed adjacent to a pressure chamber 31 of the collision sensor 3. When the distance sensor 5 is placed adjacent to the pressure chamber 31, there is a possibility that the distance sensor 5 supported by the radiator 6 functions as a factor (hereinafter, referred to as a block) blocking the propagation of the impact to the pressure chamber 31.

As a result, there is a possibility that the center portion of the front end portion in the width direction of the vehicle is included in the low output area. Especially, when the distance sensor 5 is placed more adjacent to the front end portion of the vehicle than the pressure chamber 31 of the collision sensor 3, the distance sensor 5 is more likely to function as the block.

The member functioning as the block is not limited to the distance sensor 5. A head lamp and a fog lamp may function as the block depending on a positional relationship with respect to the collision sensor 3. That is, the area of the front end portion included in the low output area is determined by characteristics depending on vehicle models (hereinafter, referred to as vehicle characteristics) such as a shape of the front end portion or an arrangement of components in the front end portion.

In one example of the present embodiment, as shown in FIG. 4, a left corner portion Z1, a center portion Z2, and a right corner portion Z3 are set as the low output area.

In the example, the left corner portion Z1 is a region within a specific distance (e.g., 0.4 meters) from a leftmost portion toward the center portion in the width direction of the vehicle. The right corner portion Z3 is a region within a specific distance (e.g., 0.4 meters) from a leftmost portion toward the center portion in the width direction of the vehicle. The center portion Z2 is a region within a specific distance (e.g., 0.1 meters) from a center toward right and left in the width direction of the vehicle.

The low output area may be expressed in a planar coordinate system (e.g., XY coordinate system) in which the front and rear direction of the vehicle corresponds to an X axis, and the width direction of the vehicle corresponds to a Y axis. For example, an origin of the XY coordinate system corresponds to a center point of the front end portion in the width direction of the vehicle. The X axis has a positive direction in the rear direction, and the Y axis has a positive direction in a direction from left toward right of the vehicle.

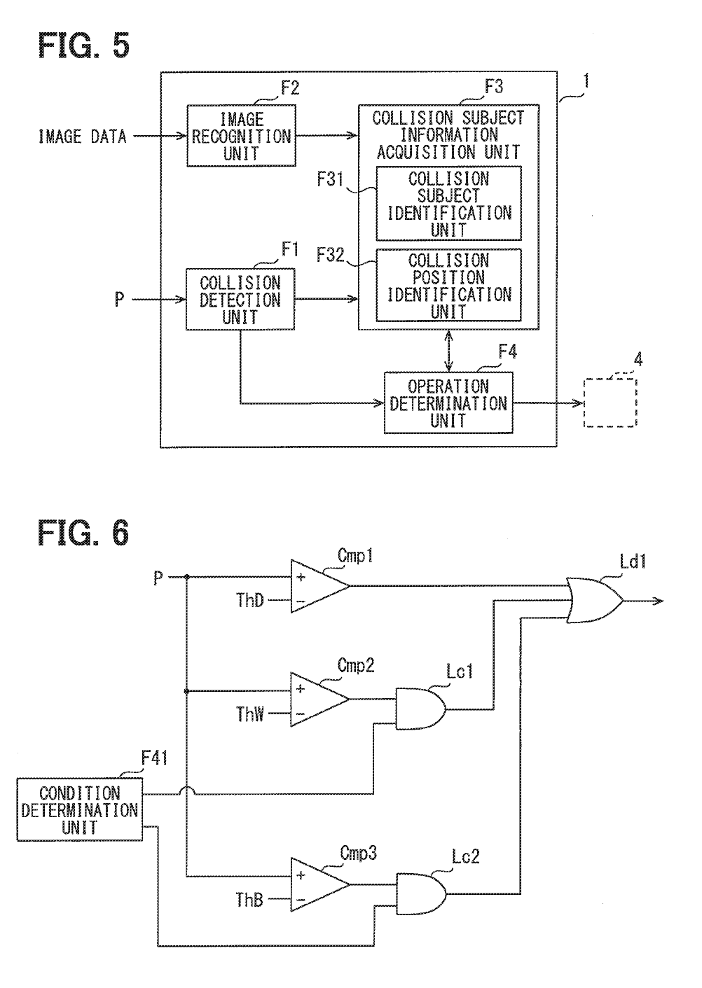

Next, functions of the ECU 1 will be described. As shown in FIG. 5, the ECU 1 includes a collision detection unit F1, an image recognition unit F2, a collision subject information acquisition unit F3 and an operation determination unit F4 as functional blocks configured by the control program stored in the ROM 13 and implemented by the CPU 11. The collision subject information acquisition unit F3 further includes a collision subject identification unit F31 and a collision position acquisition unit F32 as smaller functional blocks. Each of the functional blocks of the ECU 1 may be configured by a hardware including one or more IC and the like. In one example of the present embodiment, a part of the operation determination unit F4 is configured by a hardware.

The collision detection unit F1 acquires the output value of the collision sensor 3 and provides the output value to the operation determination unit F4. The collision detection unit F1 corresponds to an output value acquisition unit.

In more preferable embodiment, the collision detection unit F1 determines that the first collision occurs when the output value of the collision sensor 3 is equal to or greater than a collision determination threshold for determining whether the object other than the host vehicle collides with the front end portion of the host vehicle (i.e., whether the first collision occurs). Then, the collision detection unit F1 provides a collision detection signal indicating that the collision occurs in the front end portion to the collision subject information acquisition unit F3.

The image recognition unit F2 analyses the image data input by the camera 2, detects the object preliminarily set as a detection subject to be detected, and identifies a type of the object. For example, the image recognition unit F2 extracts outlines of all objects in the image by performing a well-known image processing such as an edge detection for the image data. Then, the image recognition unit F2 detects the object set as the detection subject and identifies the type of the object by performing a pattern matching processing to the image data after the image processing.

The detection subject may be suitably designed. In the present embodiment, a pedestrian and a bicycle with a crew riding on the bicycle (hereinafter, referred to as a crewed bicycle) are set as the detection subject. Setting the crewed bicycle as the detection subject corresponds to setting the crew of the bicycle as the detection subject. The object to be set as the detection subject is not limited to the above examples. Other movable body such as a motorized bicycle, two-wheel automobile and a four-wheel automobile may be set as the detection subject. A structural object such as a power pole may be set as the detection subject.

Data (hereinafter, referred to as an image recognition data) used by the image recognition unit F2 for detecting the detection subject from the image data is stored In the ROM 13. For example, the image recognition data includes data indicating a shape pattern of the detection subject.

The image recognition unit F2 estimates relative positions of the object (hereinafter, referred to as a detected object) detected in the image data and the host vehicle from a position and a size of the detected object. Regarding the detected object once detected by the image recognition unit F2, the image recognition unit F2 tracks the detected object by using a well-known object tracking method. As such, the image recognition unit F2 estimates a relative moving direction and a relative moving speed of the detected object from variation degrees of the position and the size of the same detected object between successive frames. The relative position of the detected object with respect to the host vehicle may be expressed by the XY coordinate system.

When the stereo camera is employed as the camera 2, the relative position may be estimated based on a positional difference of the same object in the image data. The result of the image recognition processing performed by the image recognition unit F2 is provided to the collision subject information acquisition unit F3. The image recognition unit F2 corresponds to an object recognition unit.

The collision subject information acquisition unit F3 acquires the result of the image recognition processing performed by the image recognition unit F2 as information about the object existing in front of the host vehicle. Specifically, the collision subject information acquisition unit F3 acquires the relative position, the relative speed and the type of each detected object as a movable body.

The collision subject information acquisition unit F3 identifies the object (hereinafter, referred to as a collision subject) colliding with the host vehicle based on the result of the image recognition processing performed by the image recognition unit F2. The collision subject identification unit F31 and the collision position acquisition unit F32 of the collision subject information acquisition unit F3 are functional blocks for acquiring several information of the collision subject.

The collision subject identification unit F31 identifies the collision subject based on the sequentially collected information of the object existing in front of the host vehicle when the collision detection unit F1 detects the occurrence of the collision. In one example of the present embodiment, the collision subject identification unit F31 determines, as the collision subject, one of the detected objects that is closest to the host vehicle at a collision time point at which the collision occurs, among the detected objects existing In front of the host vehicle. The collision time point includes a period right before the collision (e.g., 0.5 seconds before the collision).

However, when the object closest to the host vehicle has equal to or more than a specific distance (e.g., 3 meters) from the host vehicle, there is a possibility that the host vehicle is in contact with an object other than the detected object. Therefore, when the distance between the detected object closest to the host vehicle and the host vehicle is equal to or greater than the specific distance, the collision subject is determined as an object that is not detected.

In the present embodiment, the collision subject is fixed when the collision detection unit F1 detects the occurrence of the collision. However, the present disclosure is not limited to the example. The collision subject may be fixed when there is an object having a collision remaining time less than a specific time period (e.g., 0.5 seconds). The collision remaining time is a remaining time period until the collision with the host vehicle and is determined by, for example, the relative speed. That is, the collision subject may include not only the object actually having come into the first collision, but also the object going to come into the first collision.

The collision position acquisition unit F32 identifies a position (hereinafter, referred to as a collision position) where the collision subject collides with the front end portion of the host vehicle based on the recognition result of the image recognition unit F2. Specifically, a relative position of the collision subject at a time point when the collision is detected is acquired as the collision position. The collision position may be expressed by the XY coordinate system. In other embodiment, the collision position acquisition unit F32 may estimate the collision position by adjusting the relative position of the collision subject right before the collision with the relative speed and the relative moving direction at the time point.

When the collision subject identification unit F31 determines that the collision subject is the crewed bicycle, the collision position acquisition unit F32 acquires a gravity point position of the crewed bicycle as the collision position.

For example, the gravity point position of the crewed bicycle is a middle position between a front wheel and a rear wheel of the bicycle. In other embodiment, a position at which the crew rides on the bicycle (e.g., a position of a waist of the crew) may be determined as the gravity point position of the crewed bicycle. A position of a saddle support may be determined as the collision position.

The type of the collision subject as the movable body, which is identified by the collision subject identification unit F31, and the collision position, which is acquired by the collision position acquisition unit F32, are provided to the operation determination unit F4.

The operation determination unit F4 determines whether to operate the external protection device 4 based on an output value P provided from the collision detection unit F1. When the operation determination unit F4 determines to operate the external protection device 4, the operation determination unit F4 outputs an operation instruction signal for instructing the operation determination unit F4 to operate, and operates the external protection device 4.

In one example of the present embodiment, three thresholds of a default threshold, a pedestrian threshold, and a bicycle threshold are prepared, and the operation determination unit F4 uses any of the three thresholds as an operation threshold depending on the collision position and the type of the collision subject as the movable body. The operation determination unit F4 determines to operate the external protection device 4 when the output value P is greater than the threshold used as the operation threshold.

The default threshold ThD is a threshold used when the collision position is out of the low output area. The default threshold ThD may be suitably designed. Preferably, the default threshold ThD is greater than at least the collision detection threshold. Preferably, the default threshold ThD is not exceeded by the collision with an object having a mass less than a person such as small animal (e.g., cat), a road cone, and the like. For example, the default threshold ThD may be decided by tests and simulations with a dummy puppet (hereinafter, referred to as test and the like).

The pedestrian threshold ThW is a threshold assuming that the pedestrian collides in the low output area. For example, the pedestrian threshold ThW corresponds to the minimum value of the output value P output by the collision sensor 3 when the pedestrian collides in the low output area. The minimum value of the output value P, which is output by the collision sensor 3 when the pedestrian collides in the low output area, may be decided by the test and the like. The pedestrian threshold ThW is less than the default threshold ThD.

The bicycle threshold ThB is a threshold assuming that the crewed bicycle collides in the low output area. For example, the bicycle threshold ThB corresponds to the minimum value of the output value P output by the collision sensor 3 when the crewed bicycle collides in the low output area. The minimum value of the output value P, which is output by the collision sensor 3 when the crewed bicycle collides in the low output area, may be decided by the test and the like. The bicycle threshold ThB is less than the pedestrian threshold ThW.

The operation determination unit F4 determines the operation of the external protection device 4 by using the operation threshold depending on the collision position and the type of the collision subject as the movable body. An example of a configuration of the operation determination unit F4 is shown In FIG. 6. As shown in FIG. 6, the operation determination unit F4 includes a condition determination unit F41, comparators Cmp1, Cmp2 and Cmp3, AND elements Lc1 and Lc2, and an OR element Ld1.

Each of the comparators Cmp1, Cmp2 and Cmp3 is an element or a circuit having a plus input terminal and a minus input terminal. Each of the comparators Cmp1, Cmp2 and Cmp3 outputs a high-level signal (in other word, 1 in a positive logic circuit) when a value (e.g., a voltage) input to the plus input terminal is greater than the minus input terminal. Each of the plus input terminals of the comparators Cmp1, Cmp2 and Cmp3 receives the output value P of the collision sensor 3.

The minus input terminal of the comparator Cmp1 receives a voltage corresponding to the default threshold ThD. That is, the comparator Cmp1 is configured to compare the output value P of the collision sensor 3 and the default threshold ThD, and output the high-level signal when the output value P is greater than the default threshold ThD. The output of the comparator Cmp1 is input to the OR element Ld1.

The minus input terminal of the comparator Cmp2 receives a voltage corresponding to the pedestrian threshold ThW. The output of the comparator Cmp2 is input to the AND element Lc1. That is, the comparator Cmp2 is configured to compare the output value P of the collision sensor 3 and the pedestrian threshold ThW, and output the high-level signal when the output value P is greater than the pedestrian threshold ThW.

The minus input terminal of the comparator Cmp3 receives a voltage corresponding to the bicycle threshold ThB. The output of the comparator Cmp3 is input to the AND element Lc2. That is, the comparator Cmp3 is configured to compare the output value P of the collision sensor 3 and the bicycle threshold ThB, and output the high-level signal to the AND element Lc2 when the output value P is greater than the bicycle threshold ThB.

The condition determination unit F41 determines whether a condition for using the pedestrian threshold ThW as the operation threshold is satisfied and whether a condition for using the bicycle threshold ThB as the operation threshold is satisfied. The condition for using the pedestrian threshold ThW as the operation threshold corresponds to a condition for activating the determination result using the pedestrian threshold ThW. The condition for using the bicycle threshold ThB as the operation threshold corresponds to a condition for activating the determination result using the bicycle threshold ThB.

Specifically, the condition determination unit F41 initially determines whether the collision position, which is acquired by the collision position acquisition unit F32, is in the low output area. When the collision position is in the low output area, the condition determination unit F41 determines whether the collision subject, which is acquired by the collision subject identification unit F31, is the pedestrian. When the collision subject is not the pedestrian, the condition determination unit F41 determines whether the collision subject is the crewed bicycle.

When the collision position is in the low output area and the collision subject is the pedestrian, the condition determination unit F41 determines that the condition for using the pedestrian threshold ThW as the operation threshold is satisfied and outputs the high-level signal to the AND element Lc1. When the condition for using the pedestrian threshold ThW as the operation threshold is not satisfied, the condition determination unit F41 outputs the low-level signal (in other word, 0 in the positive logic circuit) to the AND element Lc1.

When the collision position is in the low output area and the collision subject is the crewed bicycle, the condition determination unit F41 determines that the condition for using the bicycle threshold ThB as the operation threshold is satisfied and outputs the high level signal to the AND element Lc2. When the condition for using the bicycle threshold ThB as the operation threshold is not satisfied, the condition determination unit F41 outputs the low level signal to the AND element Lc2.

The AND element Lc1 outputs the high level signal to the OR element Ld1 when both of the comparator Cmp2 and the condition determination unit F41 output the high level signals. That is, the AND element Lc1 outputs the high level signal to the OR element Ld1 when the collision position is in the low output area, when the collision subject is the pedestrian, and when the output value P is greater than the pedestrian threshold ThW.

The AND element Lc2 outputs the high level signal to the OR element Ld1 when both of the comparator Cmp3 and the condition determination unit F41 output the high level signals. That is, the AND element Lc2 outputs the high level signal to the OR element Ld1 when the collision position is in the low output area, when the collision subject is the crewed bicycle, and when the output value P is greater than the bicycle threshold ThB.

The OR element Ld1 is a logical element that outputs a logical sum of the multiple inputs. The OR element Ld1 outputs the high level signal when at least one of the comparator Cmp1, the AND element Lc1 and the AND element Lc2 outputs the high level signal. The operation determination unit F4 outputs the operation instruction signal for instructing the external protection device 4 to operate when the OR element Ld1 outputs the high level signal. The output signal of the OR element Ld1 may be employed as the operation instruction signal. The external protection device 4 may be configured to operate when the OR element Ld1 outputs the high level signal.

According to the above described embodiment, the operation determination unit F4 uses any of the default threshold ThD, the pedestrian threshold ThW and the bicycle threshold ThB as the operation threshold, and operates the external protection device 4 when the output value P is greater than the operation threshold.

The pedestrian threshold ThW and the bicycle threshold ThB are employed as the operation threshold when the collision position is in the low output area. The pedestrian threshold ThW and the bicycle threshold ThB are less than the default threshold ThD. That is, each of the pedestrian threshold ThW and the bicycle threshold ThB corresponds to a low output area threshold.

According to the above described embodiment, the operation determination unit F4 operates the external protection device 4 when the collision position is not in the low output area and the output value P of the collision sensor is greater than the default threshold ThD. That is, the operation determination unit F4 determines whether to operate the external protection device 4 by using the default threshold ThD as the operation threshold.

On the other hand, when the collision position is in the low output area and the collision subject is the pedestrian, the operation determination unit F4 operates the external protection device 4 when the output value P of the collision sensor is greater than the pedestrian threshold ThW. That is, when the collision position is in the low output area and the collision subject is the pedestrian, the operation determination unit F4 determines whether to operate the external protection device 4 by using the pedestrian threshold ThW as the operation threshold.

The pedestrian threshold ThW is less than the default threshold ThD. The pedestrian threshold ThW is the threshold assuming that the pedestrian collides with the low output area. According to the above embodiment, the possibility that the external protection device 4 does not operate when the pedestrian collides with the low output area can be reduced. That is, the possibility that the external protection device 4 does not operate due to the collision position of the front end portion can be reduced.

When the collision position is in the low output area and the collision subject is the crewed bicycle, the operation determination unit F4 operates the external protection device 4 when the output value P of the collision sensor is greater than the bicycle threshold ThB. That is, when the collision position is in the low output area and the collision subject is the crewed bicycle, the operation determination unit F4 determines whether to operate the external protection device 4 by using the bicycle threshold ThB as the operation threshold.

The bicycle threshold ThB is less than the default threshold ThD. The bicycle threshold ThB is the threshold assuming that the crewed bicycle collides with the low output area. According to the above embodiment, the possibility that the external protection device 4 does not operate when the crewed bicycle collides with the low output area can be reduced. That is, the possibility that the external protection device 4 does not operate due to the collision position of the front end portion can be reduced.

Furthermore, in the above embodiment, the bicycle threshold ThB is less than the pedestrian threshold ThW. The output value P of the collision sensor 3 is likely to be lower when the collision subject is the crewed bicycle than when the collision subject is the pedestrian. According to the above embodiment, in which the bicycle threshold ThB is less than the pedestrian threshold ThW, the possibility that the external protection device 4 does not operate when the collision subject is the crewed bicycle can be reduced.

For another embodiment, in order to reduce the possibility that the external protection device 4 does not operate when the collision position is in the low output area, it can be considered to sufficiently decrease the default threshold ThD so that the external protection device 4 operates when the collision position is in the low output area. This embodiment will be referred to as a comparative embodiment for convenience.

However, in the comparative embodiment, the external protection device 4 is likely to operate in the collision with the object for which the external protection device 4 does not necessarily operate (e.g., small animals or a road cone). That is, in the comparative embodiment, the external protection device 4 is likely to unnecessarily operate due to an external disturbance.

In this case, according to the present embodiment, the possibility that the external protection device 4 does not operate due to the collision position of the front end portion can be reduced while restricting a bungle of the external protection device 4. That is, the external protection device 4 operates more accurately.

Although the embodiment of the present disclosure is described, the present disclosure is not limited to the embodiment described hereinabove. Following modifications can be included in the technical scope of the present disclosure, and the present disclosure can be modified in various other ways without departing from the gist of the present disclosure.

(Modification 1)

When the collision subject identification unit F31 determines that the collision subject is the crewed bicycle, the collision subject identification unit F31 may cooperate with the image recognition unit F2 and use, as the operation threshold, a threshold according to a posture of the crewed bicycle with respect to the host vehicle. This configuration will be referred to as a modification 1.

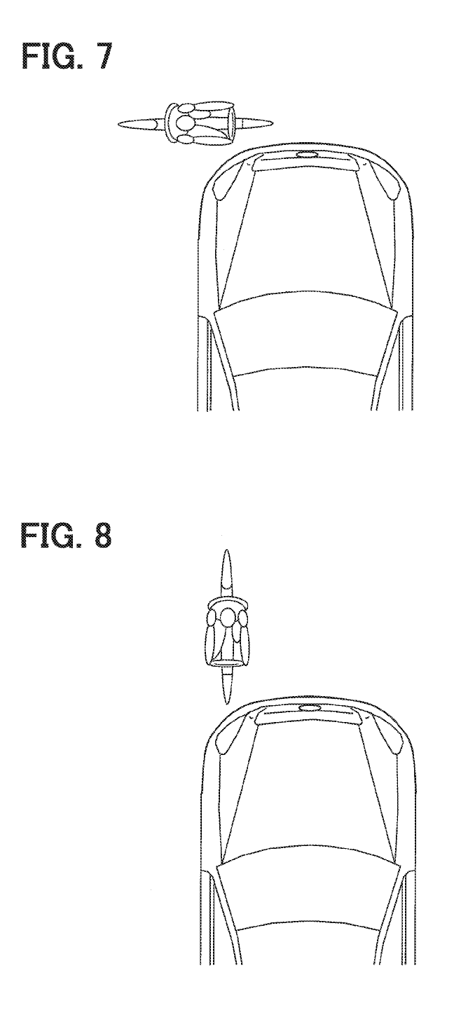

For example, the modification 1 may be implemented as follows. First, when the image recognition unit F2 detects the crewed bicycle, the image recognition unit F2 determines whether the posture of the crewed bicycle is a horizontal posture or a vertical posture. As shown in FIG. 7, the horizontal posture is a posture in which a traveling direction of the crewed bicycle is orthogonal to a traveling direction of the host vehicle. As shown in FIG. 8, the vertical posture is a posture in which the traveling direction of the crewed bicycle is parallel to the traveling direction of the host vehicle.

In this modification 1, being orthogonal is not limited to being absolutely orthogonal, and includes being approximately orthogonal. Similarly, being parallel is not limited to being absolutely parallel, and includes being approximately parallel. For example, the image recognition unit F2 determines that the posture of the crewed bicycle is the horizontal posture when an absolute value of an angle, which is formed by the traveling direction of the crewed bicycle with respect to the traveling direction of the host vehicle, is from 45 to 135 degrees. Otherwise, the image recognition unit F2 determines the posture of the crewed bicycle is the vertical posture. The image recognition unit F2 provides information indicating whether the posture of the crewed bicycle, which is the detected object, is the horizontal posture or the vertical posture to the collision subject information acquisition unit F3, together with corresponding information indicating the relative position and the type of the detected object as the movable body.

When the collision subject identification unit F31 determines that the collision subject is the crewed bicycle, the collision subject identification unit F31 further determines whether the posture of the crewed bicycle, which is the collision subject, with respect to the host vehicle is the horizontal posture or the vertical posturer based on the information provided by the image recognition unit F2.

When the posture of the crewed bicycle, which is the collision subject, is the vertical posture, the operation determination unit F4 determines whether to operate the external protection device 4 by using a threshold less than a threshold corresponding to the horizontal posture as the operation threshold. For example, the bicycle threshold includes a horizontal threshold and a vertical threshold less than the horizontal threshold. The horizontal threshold assumes that the crewed bicycle collides with the host vehicle in the horizontal posture. The vertical threshold assumes that the crewed bicycle collides with the host vehicle in the vertical posture.

The reason why the vertical threshold is less than the horizontal threshold is as follows. When the bicycle collides in the vertical posture, the wheel of the bicycle directly collides with the front end portion of the host vehicle. When the bicycle collides in the vertical posture, a contacting area of the bicycle and the front end portion of the host vehicle is small compared to the collision in the horizontal posture. Therefore, the impact of the collision is less likely to be propagated to the collision sensor 3. Especially in the low output area, the impact is likely to be released in the side direction of the host vehicle, and the impact is likely to be applied to the bicycle due to a blocking body.

The wheel of the bicycle is relatively likely to be deformed and a friction between the bicycle and a road is relatively low. Therefore, the bicycle is likely to be moved by the impact in the traveling direction of the host vehicle. As a result, compared to the collision in the horizontal posture, the impact of the collision is less likely to be propagated to the host vehicle, and the output of the collision sensor 3 is likely to be reduced.

Accordingly, when the posture of the crewed bicycle, which is the collision subject, is the vertical posture, the value less than the value for the horizontal posture is used as the operation threshold. As such, the external protection device 4 is more accurately determined to be operated.

The above described possibilities caused by the posture of the bicycle colliding are similar in an area other than the low output area of the font end portion. That is, in the area other than the low output area, the output value of the collision sensor 3 is likely to be lower in the collision in the vertical posture compared to the collision in the horizontal posture.

Therefore, when the collision position is out of the low output area but the collision subject is the crewed bicycle, the threshold according to the posture of the bicycle colliding with the host vehicle is preferably used. That is, regardless of the collision position, when the collision subject is the crewed bicycle and the posture of the bicycle in the collision is the vertical posture, the external protection device 4 is preferably determined to be operated by using the threshold less than the threshold for the horizontal threshold as the operation threshold.

In other word, the default threshold ThD preferably includes multiple thresholds such as the vertical threshold and the horizontal threshold.

(Modification 2)

In the above embodiment, when the collision position is in the low output area, the operation threshold is decided further in view of the type the collision subject as the movable body such as the pedestrian or the bicycle. However, the present disclosure is not limited to the embodiment. For example, the operation threshold may be selected only based on whether the collision position is in the low output area. This configuration will be referred to as a modification 2.

For convenience, a threshold used as the operation threshold when the collision position is in the low output area will be referred to as a low output area threshold Thα. The low output area threshold Thα is less than the default threshold ThD. However, the low output area threshold Thα is preferably greater than the output value P obtained when the small animals, the road cone or the like collide with the low output area. The low output area threshold Thα may be decided by the test and the like.

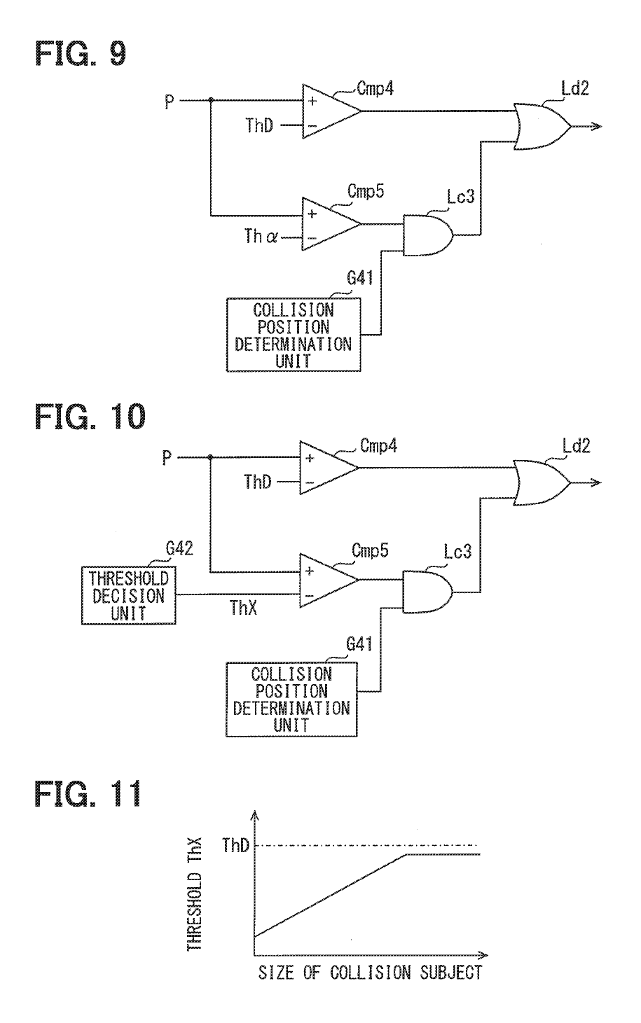

In the modification 2, the operation determination unit F4 determines the operation of the external protection device 4 by using the operation threshold according to the collision position. As shown in FIG. 9, the operation determination unit F4 includes a collision position determination unit F41, comparators Cmp1, Cmp2 and Cmp3, AND elements Lc1 and Lc2, and an OR element Ld1.

The comparator Cmp4 and the comparator Cmp5 correspond to the comparator Cmp1, the comparator Cmp2 and the comparator Cmp3 described above. The plus input terminals of the comparator Cmp4 and the comparator Cmp5 receive the output value P of the collision sensor 3.

The minus input terminal of the comparator Cmp4 receives the voltage corresponding to the default threshold ThD. The output of the comparator Cmp4 is input to the OR element Ld2. That is, the comparator Cmp4 is configured to compare the output value P of the collision sensor 3 and the default threshold ThD, and is configured to output the high level signal when the output voltage P of the collision sensor 3 is greater than the default threshold ThD.

The minus input terminal of the comparator Cmp5 receives a voltage corresponding to the low output area threshold Thα. The output of the comparator Cmp5 is input to the AND element Lc3. That is, the comparator Cmp5 is configured to compare the output value P of the collision sensor 3 and the low output area threshold Thα, and is configured to output the high level signal to the AND element Lc3 when the output voltage P of the collision sensor 3 is greater than the low output area threshold Thα.

The collision position determination unit G41 determines whether the collision position, which is acquired by the collision position acquisition unit F32, is in the low output area. When the collision position is in the low output area, the collision position determination unit G41 outputs the high level signal to the AND element Lc3. When the collision position is not in the low output area, the collision position determination unit G41 outputs the low level signal to the AND element Lc2.

The AND element Lc3 outputs the high level signal to the OR element Ld2 when both the comparator Cmp5 and the collision position determination unit G41 output the high level signals. That is, the AND element Lc3 outputs the high level signal to the OR element Ld2 when the collision position is in the low output area and the output value P is greater than the low output area threshold Thα.

The OR element Ld1 outputs the high level signal when at least one of the comparator Cmp4 and the AND element Lc2 outputs the high level signal.

The operation determination unit F4 outputs the operation instruction signal for instructing the external protection device 4 to operate when the OR element Ld2 outputs the high level signal. The output signal of the OR element Ld2 may be employed as the operation instruction signal. The external protection device 4 may be configured to operate when the OR element Ld2 outputs the high level signal.

According to the above described embodiment, the operation determination unit F4 uses the default threshold ThD as the operation threshold when the collision position is out of the low output area. On the other hand, the operation determination unit F4 uses the low output area threshold Thα as the operation threshold when the collision position is in the low output area. Then, the external protection device 4 operates when the selected operation threshold is greater than the output value P.

(Modification 3)

In the above modification 2, the low output area threshold is a fixed value. However, the present disclosure is not limited to the above modification 2. The operation determination unit F4 may acquire information indicating a size of the collision subject from the image recognition unit F2 and may dynamically adjust the low output area threshold according to the size of the collision subject. This configuration will be referred to as a modification 3. The impact of the collision is expected to increase as the size of the collision subject increases.

Hereinafter, a schematic configuration and operation of the operation determination unit F4 according to the modification 3 will be described with reference to FIG. 10 and FIG. 11. As shown in FIG. 10, the operation determination unit F4 of the modification 3 includes a collision position determination unit G41, a threshold decision unit G42, comparators Cmp4 and Cmp5, an AND element Lc3, and an OR element Ld2.

The parts having the same function as the modification 2 will be designated by the same symbols and descriptions thereof will not be repeated. When a part of the configuration is described, the remaining parts may refer to the modification 2.

The threshold decision unit G42 decides a low output area threshold ThX according to the size of the collision subject, which is identified by the image recognition unit F2. For example, the threshold decision unit G42 decides the low output area threshold ThX from information (hereinafter, referred to as a correspondence data) indicating the low output area threshold ThX corresponding to the size of the collision subject and the size of the collision subject provided from the image recognition unit F2. The correspondence data may be preliminarily stored in the ROM 13. For example, as shown in FIG. 11, the correspondence data indicates a threshold according to the size of the collision subject. The correspondence data may be expresses by a function having the size of the collision subject as variables. The correspondence data may be expressed by a map generation. The correspondence data is at least defined so that the low output area threshold ThX increases as the size of the collision subject increases.

However, when the size of the collision subject corresponds to the small animals, the collision subject is less likely to be the person. When the size of the collision subject is equal to or less than a lower limit value for determining that the collision subject is not the person, the external protection device 4 is not necessarily to be operated. Therefore, the correspondence data may be defined by a threshold equal to or greater than the lower limit value. For example, when the size of the collision subject is less than the lower limit value, the determination to operate the external protection device 4 may not be performed exceptionally.

The size of the collision subject may be estimated by a height of the collision subject from the road, or a width of the collision subject. Alternatively, the size of the collision subject may be estimated by both height and width of the collision subject. For example, the size of the collision subject corresponding to the lower limit value is defined by a size assuming a 3 to 5-year-old child.

The correspondence data is defined so that the low output area threshold ThX increases as the size of the collision subject increases. The correspondence date is defined so that the low output area threshold ThX does not exceeds the default threshold ThD. For example, the low output area threshold ThX may be set so as to converge to a predetermined value less than the default threshold ThD. The maximum value of the low output area threshold ThX will be referred to as a convergence value. The convergence value may be suitably designed.

In FIG. 11, the low output area threshold ThX increases proportional to the size of the collision subject until the low output area threshold ThX reaches the convergence value. However, the correspondence relationship of the size of the collision subject and the low output area threshold ThX is not limited to the example. The low output area threshold ThX may increase in a logarithmic function manner. Alternatively, the low output area threshold ThX may increase in a stepwise manner.

The low output area threshold ThX, which is decided by the threshold decision unit G42, is received by the minus input terminal of the comparator Cmp5. That is, the comparator Cmp5 of the modification 3 is configured to compare the output value P of the collision sensor 3 and the low output area threshold ThX decided according to the size of the collision subject. The comparator Cmp5 is configured to output the high level signal to the AND element Lc3 when the output value P of the collision sensor 3 is greater than the low output area threshold ThX.

Accordingly, when the collision position is in the low output area, the external protection device 4 is determined to be operated by using the threshold according to the size of the collision subject. Therefore, the external protection device 4 can be more accurately determined to be operated and the bungle of the external protection device 4 is restricted.

(Modification 4)

Depending on a body height, a posture, a relative position, or the like of the person to be protected, there is a possibility that the first collision occurs at a difficult portion where the collision sensor 3 has difficulty in detecting the collision. For example, the difficult portion of the front end portion of the vehicle, where the collision sensor 3 has difficulty in detecting the collision, includes a portion where the collision sensor 3 is not provided. Specifically, the difficult portion includes a portion below the pressure chamber 31.

In view of the possibility, the low output area may be defined not only in the width direction of the vehicle, but also in a height direction of the vehicle. That is, the low output area of the front end portion may be defined three-dimensionally. The low output area includes the portion where the collision sensor 3 is not provided. That is, the low output area includes a portion where the output value P of the collision sensor 3 is substantially equal to 0.

In the modification 4, when the collision position is in the portion where the collision sensor 3 is not provided, the operation determination unit F4 may operate the external protection device 4 even when the output value P of the collision sensor 3 is equal to 0. For example, when the collision position is in the portion where the collision sensor 3 is not provided, the low output area threshold ThX is set to a negative value. As such, theoretically, the output value P is greater than the operation threshold.

(Modification 5)

In the above examples, the part of the function of the operation determination unit F4 is configured by a hardware. However, the present disclosure is not limited to the examples. The processing corresponding to the circuit elements may be configured by a software. In the above examples, the part of the function of the operation determination unit F4 is configured by a software. However, the present disclosure is not limited to the examples. The entire part of the operation determination unit F4 may be configured by a hardware.

1. A protection control device for being used in a vehicle having a protection device for protecting a person colliding with the vehicle, the protection control device comprising:
an output value acquisition unit configured to acquire an output value of a collision sensor for detecting a collision of a front end portion of the vehicle with an other object;
an object recognition unit configured to acquire information about an object existing in front of the vehicle;
a collision subject identification unit configured to identify a collision subject based on the information acquired by the object recognition unit, the collision subject being a subject colliding with the vehicle;
a collision position acquisition unit configured to acquire a collision position where the collision subject collides with the front end portion of the vehicle; and
an operation determination unit configured to operate the protection device when the output value, which is acquired by the output value acquisition unit, is greater than an operation threshold for operating the protection device, wherein
the front end portion of the vehicle includes a low output area where the output value of the collision sensor is likely to be lower than an other area of the front end portion, the low output area includes a corner portion of the front end portion,
the operation determination unit uses, as the operation threshold:
a predetermined default threshold when the collision position, which is acquired by the collision position acquisition unit, is not in the low output area of the front end portion; and
a low output area threshold when the collision position, which is acquired by the collision position acquisition unit, is in the low output area of the front end portion, and
the low output area threshold is less than the predetermined default threshold.

2. The protection control device according to claim 1, wherein
the low output area threshold includes a threshold according to a type of the collision subject as a movable body,
the collision subject identification unit is configured to determine the type of the collision subject as the movable body based on the information acquired by the object recognition unit, and
the operation determination unit uses, as the operation threshold, the threshold according to the type of the collision subject as the movable body when the collision position is in the low output area.

3. The protection control device according to claim 1, wherein
the low output area threshold includes a pedestrian threshold assuming that a pedestrian collides with the low output area,
the collision subject identification unit is configured to determine whether the collision subject is the pedestrian based on the information acquired by the object recognition unit, and
the operation determination unit uses, as the operation threshold, the pedestrian threshold when the collision subject is the pedestrian and the collision position is in the low output area.

4. The protection control device according to claim 1, wherein
the low output area threshold includes a bicycle threshold assuming that a crewed bicycle collides with the low output area, the crewed bicycle being a bicycle with a crew riding on the bicycle,
the collision subject identification unit is configured to determine whether the collision subject is the crewed bicycle based on the information acquired by the object recognition unit, and
the operation determination unit uses, as the operation threshold, the bicycle threshold when the collision subject is the crewed bicycle and the collision position is in the low output area.

5. The protection control device according to claim 4, wherein
the bicycle threshold is less than a threshold assuming that a pedestrian collides with the low output area.

6. The protection control device according to claim 4, wherein
the bicycle threshold includes a horizontal threshold and a vertical threshold,
the horizontal threshold assumes that the crewed bicycle collides with the low output area in a horizontal posture in which a traveling direction of the crewed bicycle is orthogonal to a traveling direction of the vehicle,
the vertical threshold assumes that the crewed bicycle collides with the low output area in a vertical posture in which the traveling direction of the crewed bicycle is parallel to the traveling direction of the vehicle,
the vertical threshold is less than the horizontal threshold,
the operation determination unit is configured to determine whether a posture of the crewed bicycle is the horizontal posture or the vertical posture when the collision subject, which is identified by the collision subject identification unit, is the crewed bicycle, and
the operation determination unit uses, as the operation threshold:
the horizontal threshold when the posture of the crewed bicycle, which is the collision subject, is the horizontal posture; and
the vertical threshold when the posture of the crewed bicycle is the vertical posture.

7. The protection control device according to claim 1, wherein
the low output area threshold is set according to a size of the collision subject,
the collision subject identification unit is configured to acquire the size of the collision subject based on the information acquired by the object recognition unit, and
the operation determination unit uses, as the operation threshold, the low output area threshold according to the size of the collision subject acquired by the collision subject identification unit.

8. The protection control device according to claim 1, wherein
the low output area of the front end portion includes at least one of an area where a head lamp is placed and an area where a fog lamp is placed.

9. The protection control device according to claim 1, wherein
the collision sensor is placed in the front end portion along a direction of a width of the vehicle.

10. A protection control device for being used in a vehicle having a protection device for protecting a person colliding with the vehicle, the protection control device comprising:
an output value acquisition unit configured to acquire an output value of a collision sensor for detecting a collision of a front end portion of the vehicle with an other object;
an object recognition unit configured to acquire information about an object existing in front of the vehicle;
a collision subject identification unit configured to identify a collision subject based on the information acquired by the object recognition unit, the collision subject being a subject colliding with the vehicle;
a collision position acquisition unit configured to acquire a collision position where the collision subject collides with the front end portion of the vehicle; and
an operation determination unit configured to control an operation of the protection device based on the output value, which is acquired by the output value acquisition unit, wherein
the front end portion of the vehicle includes a low output area where the output value of the collision sensor is likely to be lower than an other area of the front end portion,
the low output area includes a corner portion of the front end portion, and
when the collision position, which is acquired by the collision position acquisition unit, is in the low output area of the front end portion, the operation determination unit is configured to operate the protection device by the output value less than the output value when the collision position is not in the low output area.
